(19) United States
(12) Patent Application Publication
(10) Pub. No.: US 2024/0295701 A1
(43) Pub. Date: Sep. 5, 2024

(54) OPTICAL COUPLER, VISIBLE LIGHT SOURCE MODULE AND OPTICAL ENGINE

(71) Applicant: TDK Corporation, Tokyo (JP)

(72) Inventors: Yasuhiro TAKAGI, Tokyo (JP); Hiroki HARA, Tokyo (JP); Atsushi SHIMURA, Tokyo (JP)

(73) Assignee: TDK Corporation, Tokyo (JP)

(21) Appl. No.: 18/589,472

(22) Filed: Feb. 28, 2024

(30) Foreign Application Priority Data
Mar. 2, 2023 (JP) 2023-032070

(51) Int. Cl. G02B 6/293; G02B 6/42; G02B 26/10

(52) U.S. Cl. CPC G02B 6/29344; G02B 6/4215; G02B 26/105

(57) ABSTRACT

An optical coupler of the present invention is an optical coupler that couples laser lights of three different wavelengths, and includes a two-stage MMI type optical coupler in which a first MMI type optical coupling part and a second MMI type optical coupling part are connected from the input side, and the width of the first MMI type optical coupling part is wider than the width of the second MMI type optical coupling part.

### CROSS-REFERENCE TO RELATED APPLICATION

Priority is claimed on Japanese Patent Application No. 2023-032070, filed Mar. 2, 2023, the content of which is incorporated herein by reference.

### BACKGROUND OF THE INVENTION

### Field of the Invention

The present disclosure relates to an optical coupler, a visible light source module, and an optical engine.

### Description of Related Art

Currently, glasses type terminals are being considered in xR technologies such as virtual reality (VR) and augmented reality (AR). Particularly in recent years, retinal scanning displays that allow a user to visually recognize images by focusing two-dimensionally scanned light on the user's retina have attracted attention. In general, in a retinal scanning display, three-color visible light emitted from light sources such as a light emitting diode (LED) and a laser diode (LD) corresponding to each color of R (red), G (green), and B (blue) are coupled onto one optical axis. The coupled three-color visible light is transmitted to an image display part. The image display part scans the transmitted light two-dimensionally and makes it be incident on the user's pupil. Due to this incident light forming an image on the user's retina, the user visually recognizes the image. In this case, the retina is a screen that displays the image.

For example, Patent Document 1 discloses a configuration of a retinal projection display using a Mach-Zehnder type optical modulator.

### PATENT DOCUMENTS

[Patent Document 1] Japanese Patent No. 6728596
[Patent Document 2] Japanese Patent No. 6787397
[Patent Document 3] Japanese Patent No. 6572377
[Patent Document 4] Japanese Unexamined Patent Application, First Publication No. 2012-48071
[Patent Document 5] Japanese Unexamined Patent Application, First Publication No. 2020-27170

### SUMMARY OF THE INVENTION

In the retinal projection display disclosed in Patent Document 1, although a plurality of optical waveguides are placed close to each other at an emission part, since they are not coupled, the optical axis for each of wavelengths is different, and control of the emitted light becomes complicated.

Furthermore, there is a need for an optical coupler that can be connected or integrated with a visible light modulator and can adjust an RGB color balance, but it has not been considered at all at present.

However, in Patent Document 1, the optical waveguides are only placed close to each other at the emission part and are not coupled. Therefore, the optical axis for each of wavelengths is different, and thus the control of the emitted light becomes complicated.

Further, Patent Document 2 discloses a visible light modulator using a lithium niobate film. There is a need for an RGB optical coupler that can be connected or integrated with a visible light modulator using a lithium niobate film, but it has not yet been considered.

Regarding the coupling of visible light, directional couplers are generally being considered (refer to, for example, Patent Document 3). They are made of a glass-based material and thus have excellent stability, but when a lithium niobate substrate with a large Δn is used, a coupling length becomes long, and miniaturization is not possible.

Patent Document 4 and Patent Document 5 disclose configurations of RGB couplers using multimode interferometers (MMI), but both are made of glass-based materials, and the configuration using a lithium niobate film is not disclosed at all.

In the MMI type optical coupler, a plurality of input signals are input to the optical input side using a plurality of waveguide ports, and all the input signals are coupled and output as an output signal using a single waveguide port on the optical output side.

The MMI type optical coupler is an optical coupler using characteristics in which a large number of modes generated within an optical coupler having a wide width interfere with each other for each wavelength and an image is formed (converged) at a specific position.

The present disclosure has been made in view of the above problems, and an object thereof is to provide an optical coupler, a visible light source module, and an optical engine capable of be connected to or integrated with an optical modulator using a lithium niobate film and capable of being made smaller than conventional ones.

The present disclosure provides the following means to solve the above problems.

A first aspect of the present disclosure is an optical coupler that couples laser lights of a plurality of different wavelengths, wherein a first MMI type optical coupling part and a second MMI type optical coupling part are connected from the input side, and the width of the first MMI type optical coupling part is wider than the width of the second MMI type optical coupling part.

According to a second aspect of the present disclosure, in the optical coupler of the first aspect, all of the plurality of different wavelengths may be visible light wavelengths.

According to a third aspect of the present disclosure, in the optical coupler of the first or second aspect, the optical coupler may be a 3-input and 1-output optical coupler, and the optical coupler may be configured so that laser lights of three colors are input and the laser light input from a center is laser light with a shortest wavelength.

According to a fourth aspect of the present disclosure, in the optical coupler of the third aspect, the three colors may be respectively a red wavelength of 610 nm or more and 750 nm or less, a green wavelength of 500 nm or more and 560 nm or less, and a blue wavelength of 435 nm or more and 480 nm or less.

According to a fifth aspect of the present disclosure, in the optical coupler of any one of the first to fourth aspects, a connection portion of the second MMI type optical coupling part with the first MMI type optical coupling part may have a taper of which the width becomes wider as the taper approaches the first MMI type optical coupling part.

According to a sixth aspect of the present disclosure, in the optical coupler of any one of the first to fifth aspects, the optical coupler may further include a substrate made of a material different from lithium niobate, and an optical coupling functional layer formed on a main surface of the substrate and made of a lithium niobate film, wherein the optical coupler is formed in the optical coupling functional layer.

A seventh aspect of the present disclosure is a visible light source module including the optical coupler described in the sixth aspect, and a plurality of visible laser light sources configured to emit visible lights that are coupled by the optical coupler.

An eighth aspect of the present disclosure is an optical coupler with a light modulation function, including the optical coupler described in the sixth aspect, and a Mach-Zehnder type optical modulator connected to the optical coupler and configured to guide a plurality of visible lights emitted from a plurality of visible laser light sources to the optical coupler.

A ninth aspect of the present disclosure is a visible light source module including the optical coupler with a light modulation function described in the eighth aspect, and a plurality of visible laser light sources configured to emit visible lights that are coupled by the optical coupler with a light modulation function.

A tenth aspect of the present disclosure is an optical engine including the visible light source module described in the seventh or ninth aspect, and a light scanning mirror that reflects light emitted from the visible light source module by changing an angle to display an image.

According to the present disclosure, it is possible to provide an optical coupler that can be connected or integrated with an optical modulator using a lithium niobate film and can be made smaller than conventional ones.

### BRIEF DESCRIPTION OF THE DRAWINGS

FIG. 1 is a schematic plan view of a 3-input type optical coupler as an example of an optical coupler according to a first embodiment.

FIG. 2 is a schematic plan view of a 2-input type optical coupler as another example of the optical coupler according to the first embodiment.

FIG. 3A is a diagram showing a principle of an optical coupler, and is a diagram showing a relationship between a width W_{M} and an effective width Wₑ of the optical coupler, and a single mode and a high order mode.

FIG. 3B is a diagram showing the principle of the optical coupler, and is a diagram showing simulation results of electromagnetic field distribution in a cross section of a waveguide in each of a single mode (TM0), a high order mode (TM1), and a high order mode (TM2).

FIG. 4A is a diagram showing the principle of the optical coupler, and shows results of a simulation of the electromagnetic field distribution of red (R) light.

FIG. 4B is a diagram showing the principle of the optical coupler, and shows results of a simulation of the electromagnetic field distribution of green (G) light.

FIG. 5A is a graph showing a relationship between the length of a first MMI type optical coupling part (a first stage) and the beat length and the output intensity for each of red (R) light and green (G) laser light.

FIG. 5B is a graph showing a relationship between the length of a second MMI type optical coupler (a second stage) and the beat length and the output intensity for each of red (R) light and green (G) laser light.

FIG. 6A conceptually shows a conventional one-stage MMI type optical coupler.

FIG. 6B conceptually shows a two-stage MMI type optical coupler according to the present embodiment.

FIG. 7 is a schematic plan view of another example of the optical coupler (3-input type) according to the first embodiment.

FIG. 8 is a schematic plan view of an optical coupler according to a second embodiment.

FIG. 9A is a schematic cross-sectional view taken along line X-X′ in FIG. 1 of an optical coupler in which the constituent elements shown in FIG. 1 are formed in an optical coupling functional layer made of lithium niobate.

FIG. 9B is a schematic cross-sectional view taken along line X-X′ in FIG. 2 of an optical coupler in which the constituent elements shown in FIG. 2 are formed in an optical coupling functional layer made of lithium niobate.

FIG. 10 is a schematic cross-sectional view taken along a YZ plane when an MMI type optical coupling part has a trapezoidal cross section.

FIG. 11 is a schematic cross-sectional view taken along the YZ plane when the MMI type optical coupler has a slab portion on the substrate side.

FIG. 12 is a schematic cross-sectional view taken along the YZ plane when the MMI type optical coupling part has a trapezoidal cross section and has a slab portion on the substrate side.

FIG. 13 is a schematic plan view of an optical coupler according to a fourth embodiment.

FIG. 14 is a schematic plan view of a visible light source module (including a 3-input type optical coupler) according to the first embodiment.

FIG. 15 is a schematic plan view of a visible light source module (including a 2-input type optical coupler) according to the first embodiment.

FIG. 16 is a schematic plan view of a visible light source module according to the second embodiment.

FIG. 17 is a conceptual diagram showing an optical engine according to an embodiment.

### DETAILED DESCRIPTION OF THE INVENTION

Hereinafter, embodiments will be described in detail with reference to the drawings as appropriate. In the drawings used in the following description, characteristic parts may be shown to be enlarged for convenience in order to make the characteristics easier to understand, and dimensional ratios of each of components may be different from actual ones. Materials, dimensions, and the like exemplified in the following description are merely examples, and the present disclosure is not limited thereto, and can be implemented with appropriate changes within the scope of achieving the effects of the present disclosure.

### Optical Coupler (First Embodiment)

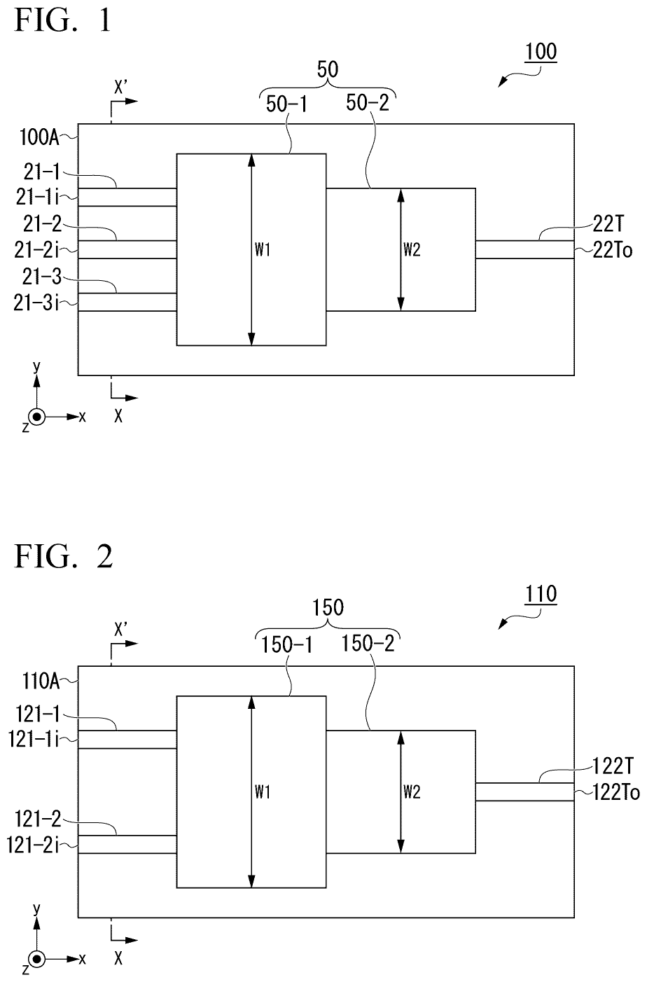

FIG. 1 is a schematic plan view of a 3-input type optical coupler as an example of an optical coupler according to a first embodiment.

The optical coupler 100 shown in FIG. 1 is an optical coupler that couples laser lights of three different wavelengths, and includes a two-stage MMI type optical coupler 50 in which a first MMI type optical coupling part 50-1 and a second MMI type optical coupling part 50-2 are connected from the input side, wherein a width W1 of the first MMI type optical coupling part 50-1 is wider than a width W2 of the second MMI type optical coupling part 50-2.

The optical coupler 100 shown in FIG. 1 is a 3×1 multimode interference (MMI) type optical coupler. Laser lights coupled by the optical coupler 100 can be, for example, three different laser lights of RGB.

In FIG. 1, an X direction is a direction perpendicular to a side surface in which a light incidence port is disposed, a Y direction is a direction perpendicular to the X direction, and a Z direction is a direction perpendicular to a plane formed by the X direction and the Y direction.

A first optical input-side optical waveguide 21-1, a second optical input-side optical waveguide 21-2 and a third optical input-side optical waveguide 21-3 respectively connected to three light incidence ports (a first light incidence port 21-1i, a second light incidence port 21-2i and a third light incidence port 21-3i) provided in a first side surface 100A are connected to the optical input side of the first MMI type optical coupling part 50-1.

On the other hand, a first optical output-side optical waveguide 22T connected to one light emission port 22To is connected to the optical output side of the second MMI type optical coupler 50-2.

Although the optical coupler 100 shown in FIG. 1 has three input ports corresponding to input laser lights of three different wavelengths, the number of input ports is not limited to three, and two or four or more input ports may be provided.

The three wavelengths may be different visible light wavelengths.

FIG. 2 is a schematic plan view of a 2-input type optical coupler as another example of the optical coupler according to the first embodiment.

The optical coupler 110 shown in FIG. 2 is an optical coupler that couples two laser beams of different wavelengths, and includes a two-stage MMI type optical coupling part 150 in which a first MMI type optical coupling part 150-1 and a second MMI type optical coupling part 150-2 are connected from the input side, wherein a width W1 of the first MMI type optical coupling part 150-1 is wider than a width W2 of the second MMI type optical coupling part 150-2.

The optical coupler 110 shown in FIG. 2 is a 2×1 multimode interference (MMI) type optical coupler. The laser lights coupled by the optical coupler 110 may be, for example, two different laser lights in visible lights.

A first optical input-side optical waveguide 121-1 and a second optical input-side optical waveguide 121-2 respectively connected to two light incidence ports (a first light incidence port 121-1i and a second light incidence port 21-2i) provided in the first side surface 110A are connected to the optical input side of the first MMI type optical coupling part 150-1. On the other hand, a first optical output-side optical waveguide 122 connected to one light emission port 1220 is connected to the optical output side of the second MMI type optical coupling part 150-2.

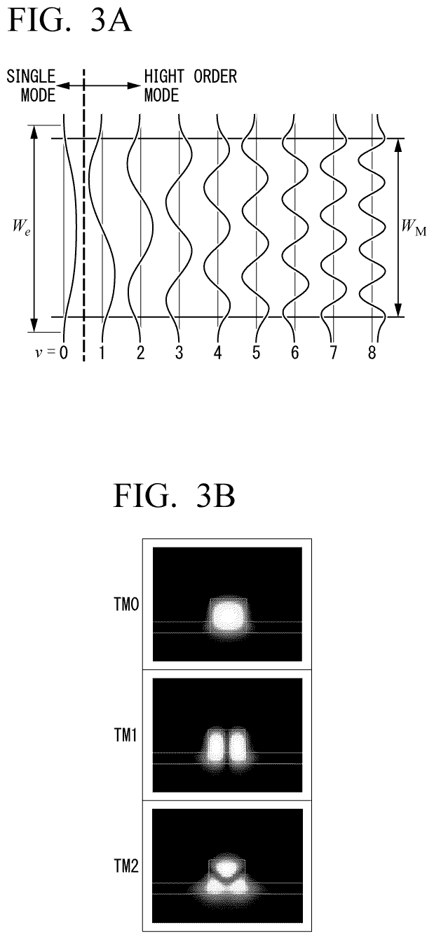

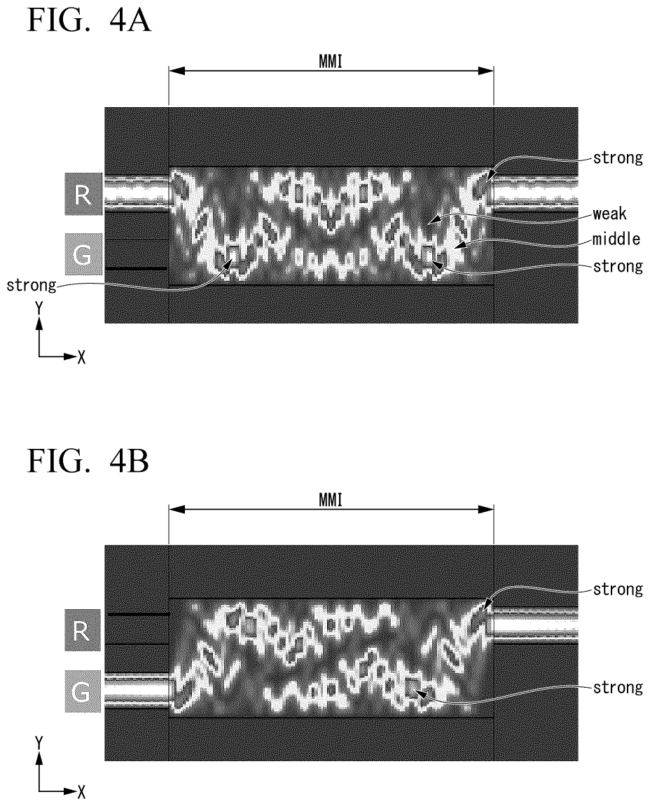

The principle of the MMI optical coupler will be described using FIGS. 3A, 3B, 4A, and 4B.

FIG. 3A shows a single mode (v=0) and a high order mode (v≥1) occurring in the width W_{M} of the MMI type optical coupler. Wₑ is an effective width of the MMI type optical coupler, and is approximated by an effective width of the MMI type optical coupler in consideration of seepage of the optical mode and Goos-Haenchen shift in the zero-order mode (the fundamental mode). FIG. 3B is a diagram showing simulation results of electromagnetic field distribution in a cross section of the waveguide in each of the single mode (TM0), the high order mode (TM1) and the high order mode (TM2).

In the MMI type optical coupler, there are characteristics in which a plurality of modes from the zero-order mode to the high order mode interfere with each other, and an image is formed (converged) at a specific position (a predetermined distance from an input end) of the MMI type optical coupler. It is known that the distance or period (the beat length) Lπ between adjacent convergence points approximately follows Equation (1). Equation (1) is the beat length Lπ between the two low-order modes including the zero-order mode and the first-order mode.

$$[ Equation 1 ]$$

$${L}_{π} = \frac{π}{{β}_{0} - {β}_{1}} ≅ \frac{4 {nW}_{e}^{2}}{3 λ} \qquad ( 1 )$$

In Equation (1), We is an effective width of the MMI type optical coupler, n is an effective refractive index of the MMI type, and A is a wavelength of input light. β₀ and β₁ are propagation constants of the zero-order mode and the first-order mode, respectively. From Equation (1), it can be understood that the beat length depends on the width and wavelength of the MMI type optical coupler.

When the electromagnetic field distribution undergoes a 2π phase change in all propagation modes generated within the MMI type optical coupler, light intensity distribution matches incident light intensity distribution. A light propagation distance required until the matching (converging) state is achieved is called a self-projection distance, and convergence is repeated at a period of Lπ after a certain propagation distance of 3Lπ/4.

FIGS. 4A and 4B show results of a simulation using simulation software (Fimmwave created by Photon Design Co.) regarding the electromagnetic field distribution in a cross section of a 2×1 MMI type optical coupler (R/G coupler) in a light propagation direction (an x direction). In a simulation model, a position (coordinates) in a y direction of the input-side waveguide through which red (R) light with a wavelength of 638 nm is input to the optical coupler is the same as a position (coordinates) in the y direction of the output-side waveguide of the optical coupler, and a position in the y direction of the input-side waveguide through which green (G) light with a wavelength of 520 nm is input to the optical coupler is separated by a predetermined distance. Lighter colored portions indicate positions in which the respective modes are strongly interfering with each other (“strong” in the drawing), darker colored portions indicate positions in which the respective modes are not strongly interfering with each other (“weak” in the drawing), and intermediate colored portions indicate positions in which the degree of interference between the modes is intermediate (“middle” in the drawing).

FIG. 4A shows results of performing a simulation of the electromagnetic field distribution of red (R) light, and FIG. 4B shows the result of performing a simulation of the electromagnetic field distribution of green (G) light.

In both FIGS. 4A and 4B, preferably, the length (the length in the X direction) of the MMI type optical coupler is set so that the optical coupler has a strongly interfering portions near the output port, and positions thereof match each other as much as possible (that is, they are as close to an integer multiple (least common multiple) of the beat length of each input wavelength as possible). However, since a phase difference according to an input position of each input wavelength to the optical coupler is affected, the length of the MMI type optical coupler cannot be determined only by an integral multiple of the beat length of each input wavelength.

Therefore, the length of the optical coupler is initially set to be an integral multiple (least common multiple) of the beat length of each input wavelength, and has to be adjusted in consideration of the influence of the phase according to the input position of each input wavelength to the optical coupler.

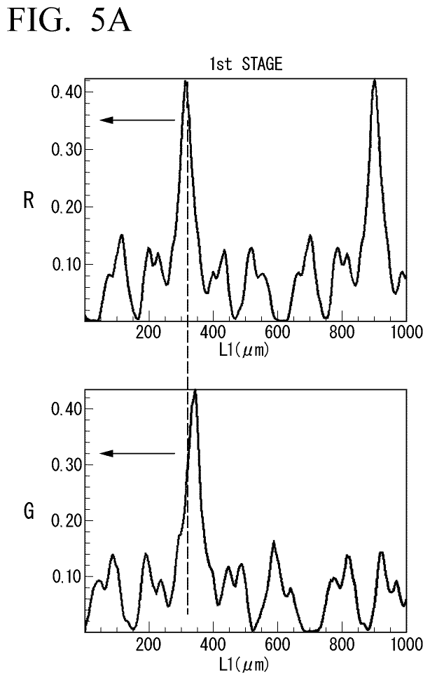

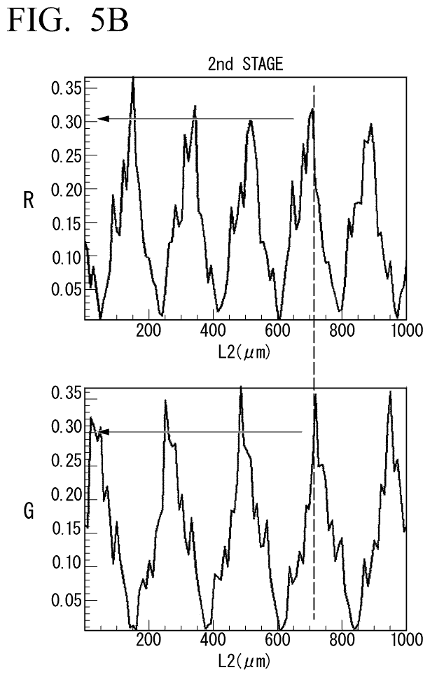

FIGS. 5A and 5B are graphs showing a relationship between the length of each of a first MMI type optical coupling part (a first stage) and a second MMI type optical coupling part (a second stage) and the beat length and the output intensity for each of red (R) and green (G) laser lights. The horizontal axis is the length (L1, L2) of the MMI type optical coupling part, and the vertical axis is the light intensity.

The beat lengths of red (R) and green (G) are different. When the length of each of the first MMI type optical coupling part and the second MMI type optical coupling part is approximately 700 μm, both red (R) and green (G) can be coupled with an output intensity of 0.3.

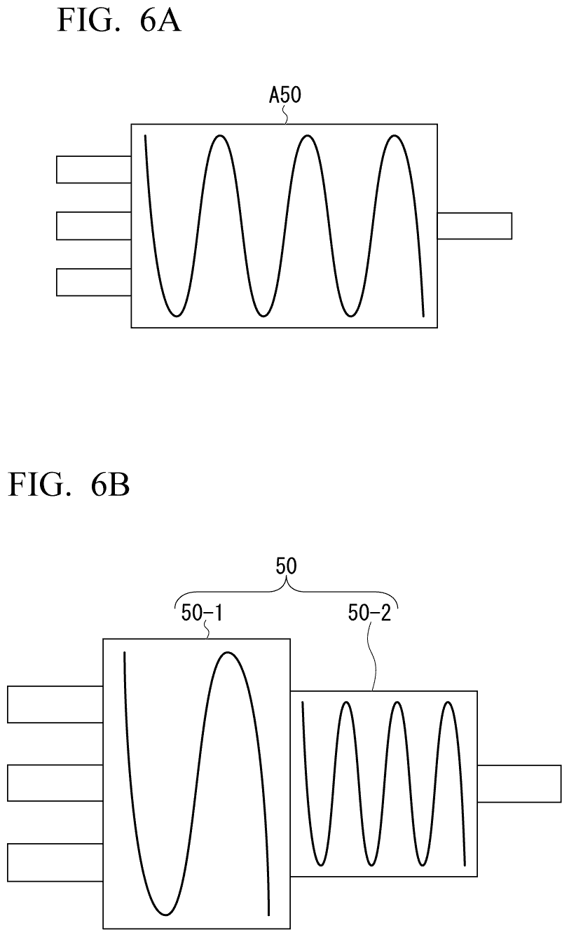

FIG. 6A conceptually shows a conventional MMI type optical coupler, and FIG. 6B conceptually shows an MMI type optical coupler according to the present embodiment.

FIG. 6A shows an MMI type optical coupler including one MMI type optical coupling part A50, and FIG. 6B includes a two-stage MMI type optical coupling part 50 in which a wide first MMI type optical coupling 50-1 and a narrow second MMI type optical coupling part 50-2 are connected from the input side.

Waves in the optical coupling part conceptually show a period of interference (the beat length), and from above Equation (1), the period of interference (the beat length) is proportional to the square of the width of the optical coupling for each wavelength. Therefore, the waves in the optical coupling part shown in FIGS. 6A and 6B conceptually show that, for each wavelength, as the width of the optical coupling part increases, the beat length (a period of beat) becomes longer, and as the width is reduced, the beat length (the period of beat) becomes shorter. As the beat length of each wavelength is shorter, a distance that is an integral multiple (least common multiple) of the beat length becomes shorter, and thus it is possible to shorten the length of the MMI optical coupling part.

According to the optical coupler according to this embodiment, as shown in FIG. 6B, in the two-stage MMI type optical coupling part, the beat length in the MMI type coupling part at the rear stage is shortened by making the width (in a y direction) of the MMI type optical coupling unit at the rear stage narrower than the width (in the y direction) of the MMI type optical coupling part in the front stage, and the optical coupling part as a whole can be made smaller.

Here, since the MMI type optical coupling part at the rear stage may have only one output port, but the width of the MMI type optical coupling part at the front stage requires a plurality of input ports, the width cannot be made as narrow as the MMI type optical coupling part at the rear stage.

For example, when it is mounted on a glasses-type terminal, from the viewpoint of current processing technology, or the like, it is preferable that the width of the MMI type optical coupling part at the front stage is 1.9 μm or more.

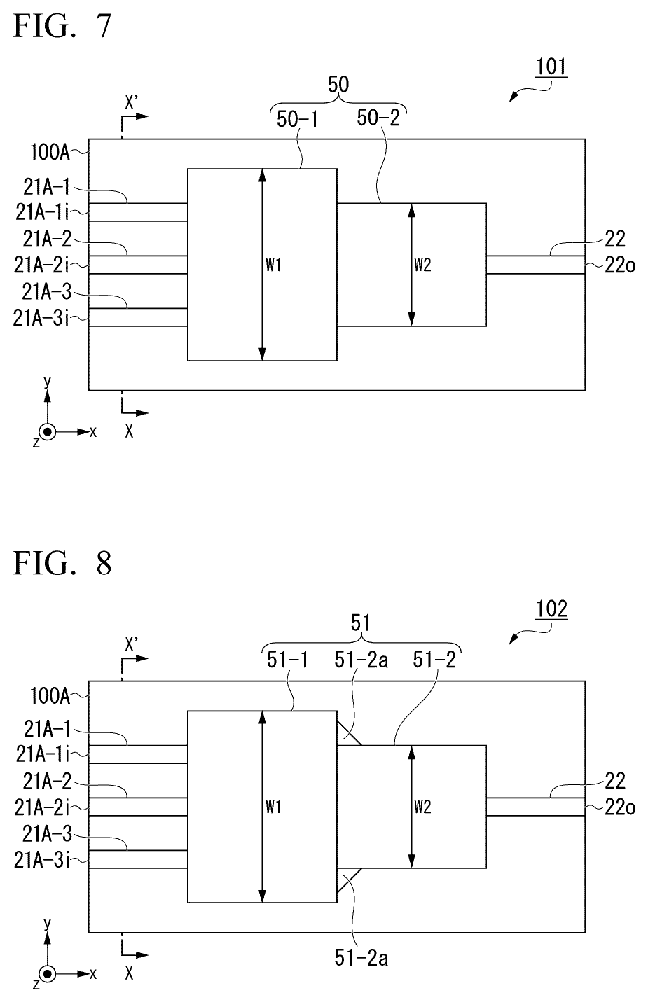

FIG. 7 is a schematic plan view showing another example of the optical coupler according to the first embodiment.

The optical coupler 101 shown in FIG. 7 is an optical coupler that couples laser lights of three different wavelengths, is a 3×1 multimode interference (MMI) type optical coupler including a two-stage MMI type optical coupling part 50 in which the first MMI type optical coupling part 50-1 and the second MMI type optical coupling part 50-2 are connected from the input side, and is common to the optical coupler 100 shown in FIG. 1 in that the width W1 of the first MMI type optical coupling part 50-1 is wider than the width W2 of the second MMI type optical coupling part 50-2, but is different therefrom in that, among three light incidence ports provided in the first side surface 100A and three optical input-side optical waveguides respectively connected to the three light incidence ports, the light incidence port located at the center and the optical input-side optical waveguide connected to the light incidence port are limited to use for laser light of the shortest wavelength.

For example, when laser lights of three different wavelengths are a red laser light with a red wavelength of 610 nm or more and 750 nm or less, a green laser light with a green wavelength of 500 nm or more and 560 nm or less, and a blue laser light with a blue wavelength of 435 nm or more and 480 nm or less, the second light incidence port 21A-2i and the second optical input-side optical waveguide 21A-2 are for blue laser light, either ones the first light incidence port 21A-1i and the first optical input-side optical waveguide 21A-1, and the third light incidence port 21A-3i and the third optical input-side optical waveguide 21A-3 are for red laser light, and the other ones are for green laser light.

In a state in which the input positions of the red and green laser lights are symmetrical with respect to the center of the optical coupler in a direction (the y direction) orthogonal to the light propagation direction, and the phases of the red and green laser lights are aligned, integral multiples of the beat lengths of the red and green laser lights are set as starting points for adjusting the length of the optical coupler, and then the length of the optical coupler can be adjusted on the basis of the beat length of blue laser light so that an output of the blue laser light can also be increased.

For the arrangement of the input ports of RGB, when red and green are left-right symmetrical, the beat length of each of red and green is shortened in the second MMI type optical coupling part, and an interference position at which beat peak positions overlap each other can be selected by adjusting the length of the second MMI type optical coupling part, and when a blue color is input from the center, since it is possible to overlap the peak position of the blue beat with the peak positions of the red and green beats, and high output can be obtained, and thus the coupling loss becomes small, this arrangement has the smallest coupling loss.

### Optical Coupler (Second Embodiment)

FIG. 8 is a schematic plan view showing an optical coupler according to a second embodiment. Regarding the constituent elements described below, constituent elements having the same functions as those in the above embodiment are designated by the same reference numerals, and the explanation thereof will be omitted.

The optical coupler 102 shown in FIG. 8 is an optical coupler that couples laser lights of three different wavelengths, is a 3×1 multimode interference (MMI) type optical coupler including a two-stage MMI type optical coupling part in which a first MMI type optical coupling part and a second MMI type optical coupling part are connected from the input side, is common to the optical coupler 100 shown in FIG. 1 in that the width of the first MMI type optical coupling part is wider than the width of the second MMI type optical coupling part, but is different therefrom in that a connection portion of the second MMI type optical coupling part with the first MMI type optical coupling part has a taper that becomes wider as it approaches the first MMI type optical coupling part.

That is, the optical coupler 102 shown in FIG. 8 is an optical coupler that couples laser lights of three different wavelengths, and includes the two-stage MMI type optical coupling part 51 in which the first MMI type optical coupling part 51-1 and the second MMI type optical coupling part 51-2 are connected from the input side, wherein the width W1 of the first MMI type optical coupling part 51-1 is wider than the width W2 of the second MMI type optical coupling part 51-2, and also the connection portion of the second MMI type optical coupling part 51-2 with the first MMI type optical coupling part 51-1 has a taper that becomes wider as it approaches the first MMI type optical coupling part (a taper connection portion 51-2a).

The configuration in which the second MMI type optical coupling part 51-2 has the taper connection portion 51-2a can be manufactured by a known method for manufacturing an optical coupler (steps similar to semiconductor processes).

In the optical coupler 102, since the second MMI type optical coupling part 51-2 has the taper connection portion 51-2a, sudden mode changes are curbed, and cracks and the like can be prevented from occurring between the first MMI type optical coupling part 51-1 and the second MMI type optical coupling part 51-2 during processing.

Although the optical coupler 102 shown in FIG. 8 has been described using an example of the optical coupler that couples laser lights of three different wavelengths, it is also possible to adopt a configuration in which an optical coupler that couples laser lights of two different wavelengths includes a taper connection portion corresponding to the taper connection portion 51-2a.

### Optical Coupler (Third Embodiment)

An optical coupler according to a third embodiment includes a substrate made of a material different from lithium niobate, and an optical coupling functional layer formed on a main surface of the substrate and made of a lithium niobate film, wherein the optical coupler according to the above embodiment is formed in the optical coupling functional layer. Regarding the constituent elements described below, constituent elements having the same functions as those in the above embodiment may be designated by the same reference numerals, and the explanation thereof may be omitted.

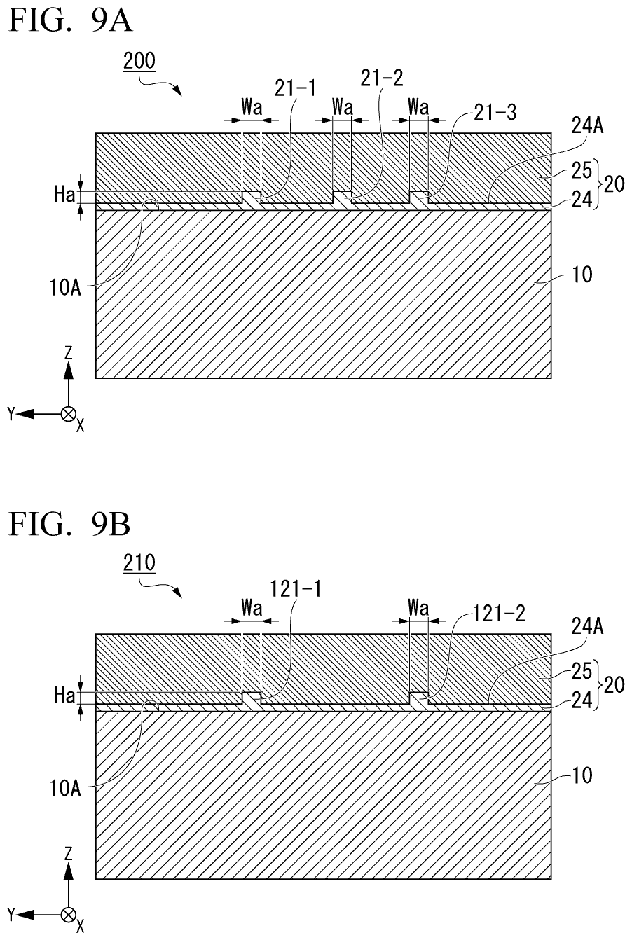

FIG. 9A is a schematic cross-sectional view taken along a YZ plane (X-X′ in FIG. 1) of the optical coupler 200 in which the optical coupler 100 shown in FIG. 1 is formed in the optical coupling functional layer made of lithium niobate, and FIG. 9B is a schematic cross-sectional view taken along the YZ plane (X-X′ in FIG. 2) of the optical coupler 210 in which the optical coupler 110 shown in FIG. 2 is formed in the optical coupling functional layer made of lithium niobate.

The optical coupler 200 shown in FIG. 9A includes a substrate 10 made of a material different from lithium niobate, and an optical coupling functional layer 20 formed on a main surface of the substrate 10 and made of lithium niobate, wherein the light incidence port, the light emission port, the first MMI type optical coupling part, the second MMI type optical coupling part, the first optical input-side optical waveguide, the second optical input-side optical waveguide, the third optical input-side optical waveguide and the first output-side optical waveguide are formed in the optical coupling functional layer 20.

Similarly, the optical coupler 210 shown in FIG. 9B includes a substrate 10 made of a material different from lithium niobate, and an optical coupling functional layer 20 formed on a main surface of the substrate 10 and made of lithium niobate, wherein the light incidence port, the light emission port, the first MMI type optical coupling part, the second MMI type optical coupling part, the first optical input-side optical waveguide, the second optical input-side optical waveguide and the first output-side optical waveguide are formed in the optical coupling functional layer 20.

In the optical coupler 200 and the optical coupler 210, in a case in which a difference in refractive index between a waveguide core film and a waveguide cladding film is Δn, when the waveguide core film is made of lithium niobate, Δn can be designed to be a larger value than when a material such as glass is used, a radius of curvature of the optical waveguide can be reduced, and an increase in the coupling length can be prevented compared to in a case of using a directional coupler by using the multimode interference type optical coupling part, and thus it is possible to achieve both improved design freedom and miniaturization.

The optical coupling functional layer 20 is configured of a waveguide core film 24 made of a lithium niobate film in which the light incidence port, the light emission port, the first optical coupling part, the second optical coupling part, the first optical input-side optical waveguide, the second optical input-side optical waveguide, the third first optical input-side optical waveguide and the first output-side optical waveguide are formed, and a waveguide cladding (buffer) film 25 formed on the waveguide core film 24 so as to cover them. Hereinafter, the reference numeral 24 may be used for the lithium niobate film.

Examples of the substrate 10 include a sapphire substrate, a Si substrate, and a thermally oxidized silicon substrate.

Since the optical coupling functional layer 20 is made of a lithium niobate (LiNbO₃) film, it is not particularly limited as long as it has a lower refractive index than that of the lithium niobate film, but as a substrate on which a single crystal lithium niobate film can be formed as an epitaxial film, a sapphire single crystal substrate or a silicon single crystal substrate is preferable. Although a crystal orientation of the single crystal substrate is not particularly limited, for example, since a c-axis oriented lithium niobate film has three-fold symmetry, it is desirable that the underlying single-crystal substrate has the same symmetry, and in the case of a sapphire single crystal substrate, a c-plane substrate is preferable, and in the case of a silicon single crystal substrate, a (111)-plane substrate is preferable.

The lithium niobate film is, for example, a c-axis oriented lithium niobate film. The lithium niobate film is, for example, an epitaxial film grown epitaxially on the substrate 10. The epitaxial film is a single crystal film of which a crystal orientation is aligned by the underlying substrate. The epitaxial film is a film that has a single crystal orientation in a z direction and an in-plane direction of an xy plane, and crystals thereof are aligned in x-axis, y-axis and z-axis directions. Whether or not the film formed on the substrate 10 is an epitaxial film can be verified, for example, by checking a peak intensity and a polar point at an alignment position in 2θ-θ X-ray diffraction.

Specifically, when measurement is performed by the 2θ-θ X-ray diffraction, all peak intensities other than a target plane are 10% or less, preferably 5% or less of the maximum peak intensity of the target plane. For example, when the lithium niobate film is a c-axis oriented epitaxial film, the peak intensity other than a (00L) plane is 10% or less, preferably 5% or less of the maximum peak intensity of the (00L) plane. Here, (00L) is a general term for equivalent surfaces such as (001) and (002).

Further, in conditions for confirming the peak intensity at the orientation position described above, only orientation in one direction is indicated. Therefore, even in the case in which the above-described conditions are obtained, when the crystal orientation is not aligned within the plane, intensity of the X-rays will not increase at a specific angular position, and no pole point will be observed. For example, when the lithium niobate film is a lithium niobate film, since LiNbO₃ has a trigonal crystal structure, LiNbO₃ (014) in the single crystal has three pole points. In the case of lithium niobate, it is known that epitaxial growth occurs in a so-called twin crystal state in which crystals rotated by 180° around the c-axis are symmetrically coupled. In this case, two of the three pole points are symmetrically connected, and thus there are six pole points. Furthermore, when a lithium niobate film is formed on a (100) plane silicon single crystal substrate, 4×3=12 pole points are observed because the substrate has a four-fold symmetry. In the present disclosure, the lithium niobate film epitaxially grown in the twin crystal state is also included in the epitaxial film.

The composition of lithium niobate is LiₓNbA_{y}O_{z}. A is an element other than Li, Nb, and O. x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. The element of A includes, for example, K, Na, Rb, Cs, Be, Mg, Ca, Sr, Ba, Ti, Zr, Hf, V, Cr, Mo, W, Fe, Co, Ni, Zn, Sc, Ce, and two or more of these elements may be combined.

Further, the lithium niobate film may be a lithium niobate single crystal thin film bonded onto a substrate.

A thickness of the lithium niobate film is, for example, 2 μm or less. The thickness of the lithium niobate film refers to a thickness of a portion other than a ridge. The thickness of the lithium niobate film may be optimally designed according to the wavelength used, the shape of the ridge, or the like.

The waveguide is a ridge protruding from a first surface 24A of the lithium niobate film 24. The first surface 24A is an upper surface of a portion (a slab layer) of the lithium niobate film 24 other than the ridge.

As shown in FIGS. 9A and 9B, a cross-sectional shape of a regular cross-sectional shape portion of each of the first optical input-side optical waveguide 21-1, the second optical input-side optical waveguide 21-2, the third optical input-side optical waveguide 21-3, and the first optical input-side optical waveguide 121-1 and the second optical input-side optical waveguide 121-2 are rectangular, but any shape that can guide light may be used, for example, it may have a trapezoidal shape, a triangular shape, a semicircular shape, or the like. A width Wa of three ridges in the y direction is preferably 0.2 μm or more and 5.0 μm or less, and a height of each of the three ridges (a protrusion height Ha from the first surface 24A) is preferably, for example, 0.1 μm or more and 1.0 μm or less. The same applies to other optical waveguides.

Propagation into a single mode can be achieved by setting a size of each of the first optical input-side optical waveguide 21-1, the second optical input-side optical waveguide 21-2, the third optical input-side optical waveguide 21-3, the first optical input-side optical waveguide 121-1, the second optical input-side optical waveguide 121-2 and other optical waveguides shown in FIG. 2 approximately to the wavelength of the laser light.

### <MMI Type Optical Coupling Part>

(1) MMI Type Optical Coupling Part with Trapezoidal Cross Section (First MMI Type Optical Coupling Part and Second MMI Type Optical Coupling Part)

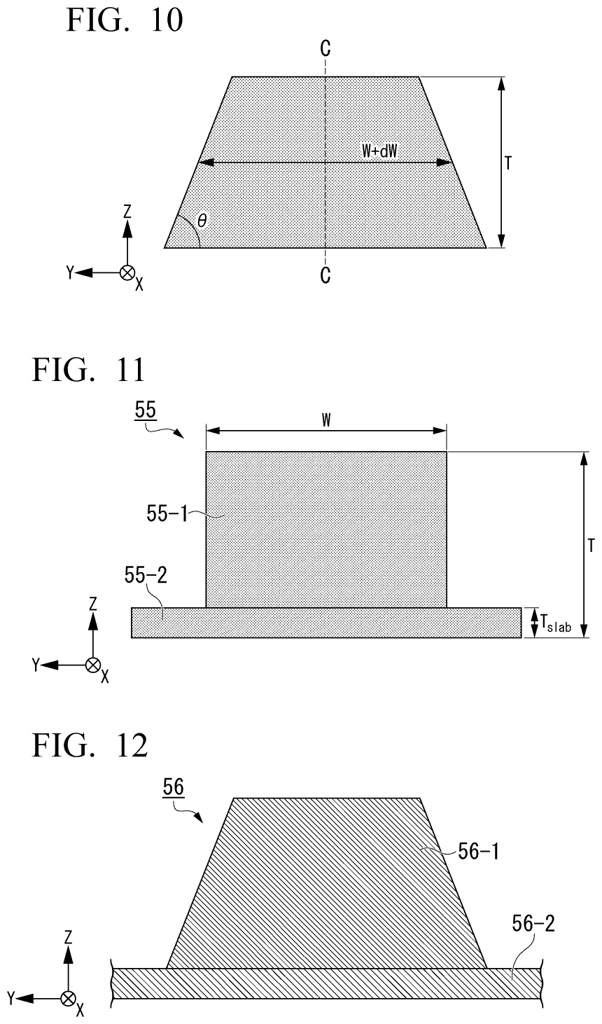

Preferably, the MMI type optical coupling part (hereinafter, in the description of FIGS. 10 to 12, the first MMI type optical coupling part and the second MMI type optical coupling part are referred to as “MMI type optical coupling part” as a common description) may have a trapezoidal cross section taken in a direction perpendicular to a traveling direction of light, as shown in FIG. 10. Further, preferably, an inclination angle θ of the trapezoidal shape may be 40° to 85°.

This is because the dimensional margin of a width W of the MMI type optical coupling part is improved, the width of the optimal MMI type optical coupling part is increased, and processing becomes easier.

This result was obtained by comparing the light propagation losses of the three colors of RGB through a simulation when the cross section of the MMI type optical coupling part cut in the direction perpendicular to the traveling direction of light is trapezoidal, and it is rectangular.

In a model used in this simulation, assuming that a height T of the MMI type optical coupling part (a ridge) is 0.7 μm, and the width at ½ of the height T of the MMI type optical coupling part is W, while a center C-C of the ridge is fixed and an inclination angle θ between a lower surface and an inclined portion is fixed, a simulation of the propagation loss during RGB coupling is performed by expanding or contracting it by dW/2 on both sides (therefore, dW in total).

When θ is 85°, 70° and 40°, the margins were all 0.3 μm, and the optimal widths W1 of the first MMI type optical coupling part were 13.2 μm, 13.2 μm and 13.5 μm.

(2) MMI Type Optical Coupling Part with Slab Portion

The MMI type optical coupling part may have a slab portion on the substrate side, as shown in FIG. 11. The MMI type optical coupling part 55 shown in FIG. 11 has a ridge 55-1 and a slab portion 55-2 on the substrate side.

A width dimension margin may be further expanded by having the slab portion, and processing may be further facilitated. In addition, the optimum width W may be further expanded, and processing may be further facilitated. When the MMI type optical coupling part has the configuration of the model shown in FIG. 11, a simulation of the propagation loss (dB) of the fundamental mode (TM0) and the high order modes (TM1 and TM2) of each of the three RGB colors during RGB coupling was performed. A height Tslab of the slab portion is 0.2 μm, and a height T of the MMI type optical coupling part is the sum of the height of the ridge 55-1 and the height of the slab portion 55-2. The width W1 of the first MMI type optical coupling part is 13 μm.

For comparison, the light propagation loss in a case without the slab portion and in a case with the slab portion was compared, in the case with the slab portion, a difference in the propagation loss between RGB was reduced compared to the case without the slab portion. Furthermore, due to a difference in the propagation loss between the case with the slab portion and the case without the slab portion, the propagation loss of the high order modes was increased, resulting in curbed propagation. Therefore, it was understood that the case with the slab portion is effective for achieving the single mode.

Further, as shown in FIG. 12, the MMI type optical coupling part 56 having a trapezoidal cross section may have a ridge 56-1 and further a slab portion 56-2 on the substrate side. Due to the slab portion being provided, the width dimension margin is further expanded, and the optimum width W is further expanded, which may further facilitate processing.

### Optical Coupler (Fourth Embodiment)

An optical coupler according to a fourth embodiment of the present disclosure includes a substrate made of a material different from lithium niobate, and an optical coupling functional layer made of a lithium niobate film and formed on a main surface of the substrate, and the optical coupler according to the above embodiment and a Mach-Zehnder type optical modulator which is connected to the optical coupler and guides a plurality of visible lights emitted from a plurality of visible laser light sources to the optical coupler are integrated and formed in the optical coupling functional layer. Regarding constituent elements described below, the constituent elements having the same functions as those in the above embodiment may be designated by the same reference numerals, and the explanation thereof may be omitted.

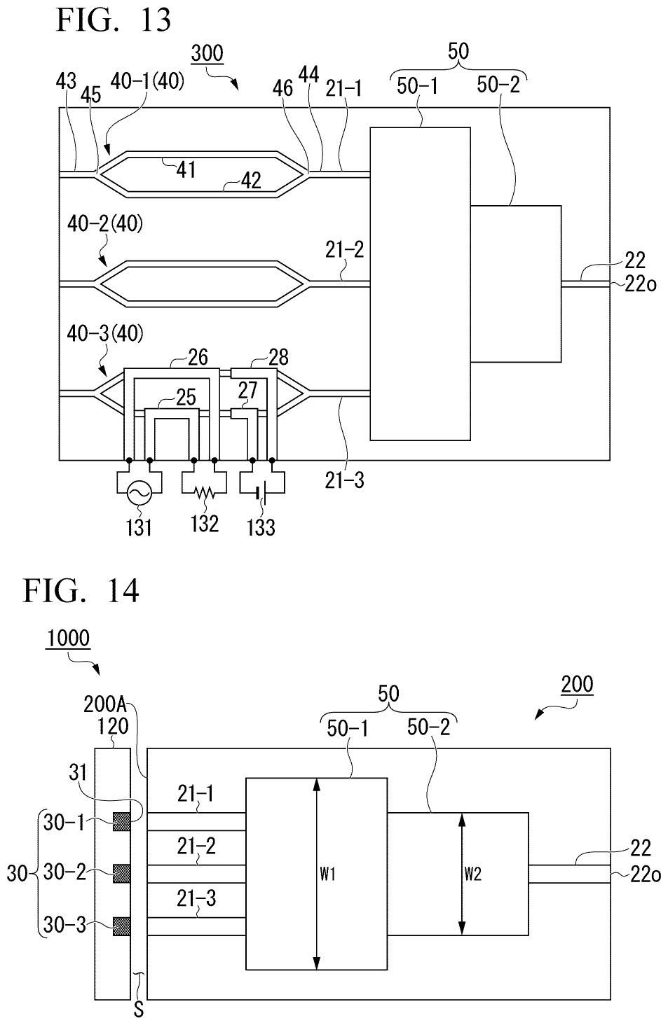

FIG. 13 is a schematic plan view of the optical coupler according to the fourth embodiment.

The optical coupler 300 shown in FIG. 13 includes a substrate 10 made of a material different from lithium niobate (refer to FIGS. 9A and 9B), and an optical coupling functional layer 20 made of a lithium niobate film and formed on a main surface of the substrate 10, wherein the optical coupler 300 with a light modulation function is formed in the optical coupling functional layer 20.

The optical coupler 300 with a light modulation function includes the 3×1 type optical coupler 50 (refer to FIG. 1) according to the above embodiment and a Mach-Zehnder type optical modulator 40.

The Mach-Zehnder type optical modulator 40 includes three Mach-Zehnder type optical waveguides 40-1, 40-2 and 40-3, but two or four or more Mach-Zehnder type optical waveguides may be provided according to the number of input ports of the first MMI type optical coupling part 50-1.

The optical coupler 300 with an optical modulation function has a configuration that uses the 3×1 type optical coupler 50 as an optical coupler, but instead of the 3×1 type optical coupler 50, a 2×1 type optical coupler 150 (refer to FIG. 2) may be used.

A known Mach-Zehnder type optical modulator or an optical waveguide may be used as the Mach-Zehnder type optical modulator 40, and a light beam in which a wavelength and a phase are aligned is split (decoupled) into two pairs of beams, each given a different phase, and then merged (coupled). The intensity of the coupled light beam changes according to a difference in phase difference.

Each of the Mach-Zehnder type optical waveguides 40 (40-1, 40-2 and 40-3) shown in FIG. 13 includes a first optical waveguide 41, a second optical waveguide 42, an input path 43, an output path 44, a branching part 45, and a coupling part 46.

The first output path 44 of the Mach-Zehnder type optical waveguide 40-1 is connected to the first MMI type optical input-side optical waveguide 21-1 of the optical coupling part main body 50-1. Further, the first output path 44 of the Mach-Zehnder type optical waveguide 40-2 is connected to the second optical input-side optical waveguide 21-2 of the optical coupling part main body 50-1. Further, the first output path 44 of the Mach-Zehnder type optical waveguide 40-3 is connected to the third optical input-side optical waveguide 21-3 of the optical coupling part main body 50-1.

Although the first optical waveguide 41 and the second optical waveguide 42 shown in FIG. 13 have a configuration in which they extend linearly in the x direction except for the vicinity of the branching part 45 and the vicinity of the coupling part 46, they are not limited to such a configuration. Lengths of the first optical waveguide 41 and the second optical waveguide 42 shown in FIG. 13 are approximately the same. The branching part 45 is located between the input path 43 and the first optical waveguide 41 and the second optical waveguide 42. The input path 43 is connected to the first optical waveguide 41 and the second optical waveguide 42 via the branching part 45. The coupling part 46 is located between the first optical waveguide 41 and the second optical waveguide 42 and the output path 44. The first optical waveguide 41 and the second optical waveguide 42 are connected to the output path 44 via the coupling part 46.

Electrodes 25 and 26 are electrodes that apply a modulation voltage to each of the Mach-Zehnder type optical waveguides 40-1, 40-2 and 40-3 (hereinafter, sometimes simply referred to as “each of the Mach-Zehnder type optical waveguides 40”). The electrode 25 is an example of a first electrode, and the electrode 26 is an example of a second electrode. One end of the electrode 25 is connected to a power source 131, and the other end is connected to a terminating resistor 132. One end of the electrode 26 is connected to the power source 131, and the other end is connected to the terminating resistor 132. The power source 131 is part of a drive circuit that applies a modulation voltage to each of the Mach-Zehnder type optical waveguides 40. The electrodes 25 and 26 are shown only in a portion of the Mach-Zehnder type optical waveguide 40-3 to simplify the drawing.

Electrodes 27 and 28 are electrodes that apply a direct-current bias voltage to each of the Mach-Zehnder type optical waveguides 40. One end of the electrode 27 and one end of the electrode 28 are connected to a power source 133. The power source 133 is part of a direct-current bias application circuit that applies a direct-current bias voltage to each of the Mach-Zehnder type optical waveguides 40.

When a direct-current bias voltage is superimposed on the electrodes 25 and 26, the electrodes 27 and 28 may not be provided. Further, a ground electrode may be provided around the electrodes 25, 26, 27 and 28.

### Visible Light Source Module (First Embodiment)

A visible light source module according to a first embodiment includes the optical coupler according to this embodiment and a plurality of visible laser light sources which emit visible lights that are coupled by the optical coupler.

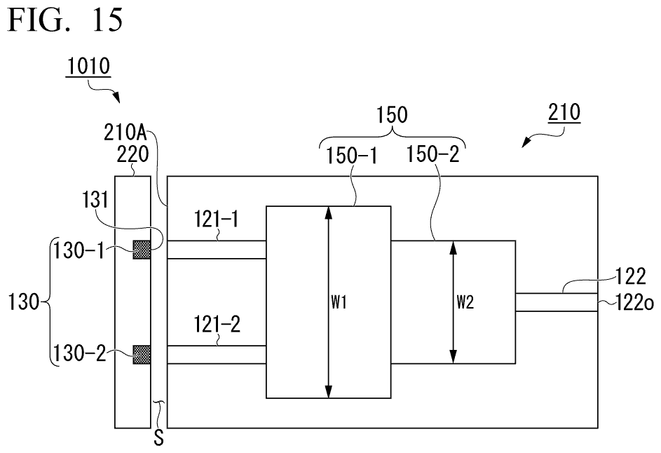

FIG. 14 is a schematic plan view of the visible light source module according to the first embodiment. FIG. 14 shows an example of a visible light source module including the optical coupler 200 (3-input type) shown in FIG. 9A. Further, FIG. 15 is a schematic plan view of a visible light source module including the optical coupler 210 (2-input type) shown in FIG. 9B.

The visible light source module 1000 shown in FIG. 14 includes an optical coupler 200 including a two-stage MMI type optical coupler 50 in which a first MMI type optical coupler 50-1 and a second MMI type optical coupler 50-2 are connected, and three visible laser light sources 30 (30-1, 30-2 and 30-3) that emit visible lights to be coupled by the optical coupler 200. The optical coupler 200 includes the substrate 10 (refer to FIGS. 9A and 9B) made of a material different from lithium niobate, and the optical coupling functional layer 20 (refer to FIGS. 9A and 9B) formed on a main surface of the substrate 10 and made of lithium niobate, and has a side surface 200A. The optical coupler included in the visible light source module 1000 shown in FIG. 14 may be the optical coupler 100.

Regarding the constituent elements shown in FIG. 14, the constituent elements having the same functions as those described above may be designated by the same reference numerals, and the explanation thereof may be omitted.

The visible light source module 1010 shown in FIG. 15 includes an optical coupler 210 including a two-stage MMI optical coupling part 150 in which a first MMI optical coupling part 150-1 and a second MMI optical coupling part 150-2 are connected, and two visible laser light sources 130 (130-1 and 130-2) that emit visible lights that are coupled by the optical coupler 210. The optical coupler 210 includes a substrate 10 (refer to FIGS. 9A and 9B) made of a material different from lithium niobate, and an optical coupling functional layer 20 (refer to FIGS. 9A and 9B) formed on a main surface of the substrate 10 and made of lithium niobate, and has a side surface 210A. The optical coupler included in the visible light source module 1000 shown in FIG. 15 may be the optical coupler 110.

Regarding the constituent elements shown in FIG. 15, constituent elements having the same functions as those described above may be denoted by the same reference numerals, and the explanation thereof may be omitted.

Various laser elements can be used as the visible laser light source 30, 130. For example, commercially available laser diodes (LDs) emitting red light, green light, blue light, and the like can be used. Light with a peak wavelength of 610 nm to 750 nm can be used as red light, light with a peak wavelength of 500 nm or more and 560 nm or less can be used as green light, and light with a peak wavelength of 435 nm or more and 480 nm or less can be used as blue light.

In the visible light source module 1000, the visible laser light sources 30-1, 30-2 and 30-3 are an LD that emits green light, an LD that emits blue light, and an LD that emits red light. The LDs 30-1, 30-2 and 30-3 are disposed at an interval from each other in a direction substantially perpendicular to an emission direction of light emitted from each of the LDs and are provided on an upper surface of a subcarrier 120.

In the visible light source module 1010, the visible laser light sources 130-1 and 130-2 can be, for example, an LD that emits green light and an LD that emits red light, respectively. The LDs 130-1 and 130-2 are disposed at an interval from each other in a direction substantially perpendicular to an emission direction of light emitted from each of the LDs and are provided on an upper surface of the subcarrier 220.

In the visible light source modules 1000 and 1010, the cases in which the number of visible laser light sources is two and three, respectively, have been exemplified, but the number of the visible laser light sources is not limited to three, and the number may be four or more. The plurality of visible laser light sources may all emit light of different wavelengths, or the plurality of visible laser light sources may emit light of the same wavelength. In addition, lights other than red (R), green (G), and blue (B) can be used for the emitted light, and a mounting order of red (R), green (G), and blue (B) described using the drawings is not necessarily in this order and can be changed as appropriate.

The LD 30 can be mounted on the subcarrier 120 as a bare chip. Similarly, the LD 130 can be mounted on the subcarrier 220 as a bare chip. The subcarrier 120, 220 is made of, for example, aluminum nitride (AlN), aluminum oxide (Al₂O₃), silicon (Si), or the like.

The subcarrier 120, 220 may be directly bonded to the substrate 10 via a metal bonding layer. With such a configuration, further miniaturization is possible by not performing spatial coupling or fiber coupling.

A relative position between the subcarrier 120 and the substrate 10 can be adjusted during manufacturing by configuring the subcarrier 120 and the substrate 10 to be bonded via the metal bonding layer, and alignment of a position of an optical axis of visible laser light can be performed so that the optical axis of each optical laser matches respective axes of the first optical input-side optical waveguide 21-1, the second optical input-side optical waveguide 21-2, and the third optical input-side optical waveguide 21-3 (active alignment). The same applies to a configuration in which the subcarrier 220 and the substrate 10 are bonded via a metal bonding layer.

In the visible light source module 1000, the three first optical input-side optical waveguide 21-1, second optical input-side optical waveguide 21-2 and third optical input-side optical waveguide 21-3 of the first MMI type optical coupling part 50-1 respectively face the emission ports of the LDs 30 (30-1, 30-2 and 30-3), and are positioned so that the light emitted from an emission surface of each of the LDs 30 can be incident on the first optical input-side optical waveguide 21-1, the second optical input-side optical waveguide 21-2 and the third optical input-side optical waveguide 21-3. The respective axes of the first optical input-side optical waveguide 21-1, the second optical input-side optical waveguide 21-2 and the third optical input-side optical waveguide 21-3 approximatively overlap the optical axis of the laser light emitted from the emission port of each of the LDs 30. Due to such a configuration and arrangement, blue light, green light, and red light emitted from the LDs 30-1, 30-2 and 30-3 can be incident on the three first optical input-side optical waveguides 21-1, second optical input-side optical waveguide 21-2 and third optical input-side optical waveguide 21-3 of the first MMI type optical coupling part 50-1. The same applies to the visible light source module 1010, and the two first optical input-side optical waveguides 121-1 and second optical input-side optical waveguide 121-2 of the first MMI type optical coupling part 150-1 face the emission port of each of the LDs 130 (130-1 and 130-2), and is positioned so that the light emitted from the output surface of each of the LDs 130 can be incident on the first optical input-side optical waveguide 121-1 and the second optical input-side optical waveguide 121-2.

In the visible light source module 1000, a light emission surface 31 of the LD 30 and a light incidence surface (a side surface) 200A of the optical coupler 200 are disposed at a predetermined interval. The light incidence surface 200A faces the light emission surface 31, and there is a gap S between the light emission surface 31 and the light incidence surface 200A in the x direction. Since the visible light source module 1000 is exposed to air, the gap S is filled with air. Since the gap S is filled with the same gas (air), it is easy to make each color light emitted from each of the LDs 30 be incident on an incidence path in a state in which a predetermined coupling efficiency is satisfied. When the visible light source module 1000 is used for AR glasses or VR glasses, a size of the gap (interval) S in the x direction is, for example, larger than 0 μm and smaller than 5 μm, considering the amount of light required for the AR glasses or VR glasses.

The same applies to the visible light source module 1010, the light emission surface 131 of the LD 130 and the light incidence surface (the side surface) 210A of the optical coupler 210 are disposed at a predetermined interval. The light incidence surface 210A faces the light emission surface 131, and there is a gap S between the light emission surface 131 and the light incidence surface 210A in the x direction.

### Visible Light Source Module (Second Embodiment)

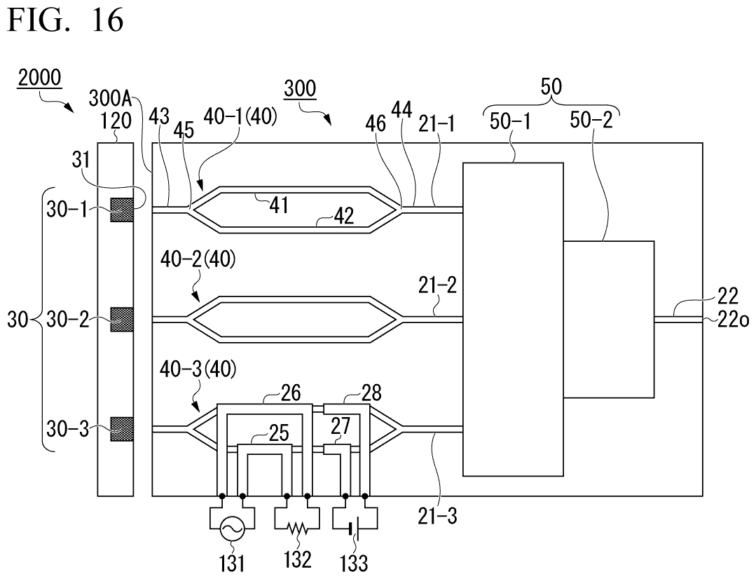

FIG. 16 is a schematic plan view of the visible light source module according to the second embodiment. The visible light source module 2000 shown in FIG. 16 includes the optical coupler 300 with a light modulation function shown in FIG. 13 and a plurality of visible light laser light sources 30 (30-1, 30-2, 30-3) which emit visible lights that are coupled by the optical coupler 300 with a light modulation function. The optical coupler 300 includes a substrate 10 (refer to FIGS. 9A and 9B) made of a material different from lithium niobate, and an optical coupling functional layer 20 (refer to FIGS. 9A and 9B) formed on a main surface of the substrate 10 and made of lithium niobate, and has a side surface 300A.

Regarding the constituent elements shown in FIG. 16, constituent elements having the same functions as those described above may be designated by the same reference numerals, and a description thereof may be omitted.

The visible light source module 2000 has a configuration that uses a 3×1 type optical coupler 50 as the optical coupler, but instead of the 3×1 type optical coupler 50, a 2×1 type optical coupler 150 (refer to FIG. 2) may be used.

The visible light source module 2000 includes three Mach-Zehnder type optical waveguides 40-1, 40-2 and 40-3 of which the number is the same as that of the visible laser light sources 30-1, 30-2 and 30-3. The visible laser light sources 30-1, 30-2 and 30-3 and the Mach-Zehnder type optical waveguides 40-1, 40-2 and 40-3 are positioned so that the lights emitted from the visible light laser light sources are incident on the corresponding Mach-Zehnder type optical waveguides.

The subcarrier 120 on which the visible laser light sources 30-1, 30-2 and 30-3 are mounted and the substrate 10 on which the optical coupling functional layer 20 having the optical coupler 300 with a light modulation function is formed can be directly bonded via a metal bonding layer. With such a configuration, further miniaturization is possible by not performing spatial coupling or fiber coupling.

In addition, a relative position between the subcarrier 120 and the substrate 10 is adjusted during manufacturing, and alignment of the position of the optical axis of the visible laser light can be performed so that the optical axis of each optical laser matches the axis of each of the input paths 43 of the Mach-Zehnder type optical waveguides 40-1, 40-2 and 40-3 (active alignment).

A size of the optical coupling functional layer 20 is, for example, 100 mm² or less. When the size of the optical coupling functional layer 20 is 100 mm² or less, it is suitable for use in xR glasses such as AR glasses and VR glasses.

The optical coupling functional layer 20 can be produced by a known method. For example, the optical coupling functional layer 20 is manufactured using a semiconductor process such as epitaxial growth, photolithography, etching, vapor phase growth, and metallization.

When the visible light source module according the present invention is applied as xR glasses such as AR glasses and VR glasses, the width of each of the first MMI type optical coupling part and the second MMI type optical coupling part constituting the optical coupler is preferably about 1 to 1000 μm, and the length thereof is preferably about 10 to 10000 μm, for example.

For example, in a retinal projection display, in order to display an image in a desired color, it is necessary to independently and quickly modulate an intensity of each of three colors of RGB representing visible light. When such modulation is performed only on a visible laser light source (current modulation), a load on an IC that controls the modulation will become large, but modulation (voltage modulation) by the Mach-Zehnder type optical modulator 40 (the optical coupler 300 with a light modulation function) can also be used. In this case, coarse adjustment may be performed using a current (the visible laser light source), and fine adjustment may be performed using a voltage (the Mach-Zehnder type optical modulator 40), and also the coarse adjustment may be performed using the voltage (the Mach-Zehnder type optical modulator 40), and the fine adjustment may be performed using the current (the visible laser light source).

Preferably, since it is better to make fine adjustments using the voltage, when responsiveness is important, the former is adopted, and since performing fine adjustment using a current requires a lower current and thus curbs power consumption, when curbing power consumption is important, the latter is adopted.

### [Optical Engine]

In the specification, an optical engine is a device including a plurality of light sources, an optical system including a coupling part that couples a plurality of lights emitted from the plurality of light sources into one light, and a light scanning mirror that reflects the light emitted from the optical system by changing an angle so as to display an image, and a control element that controls the light scanning mirror.

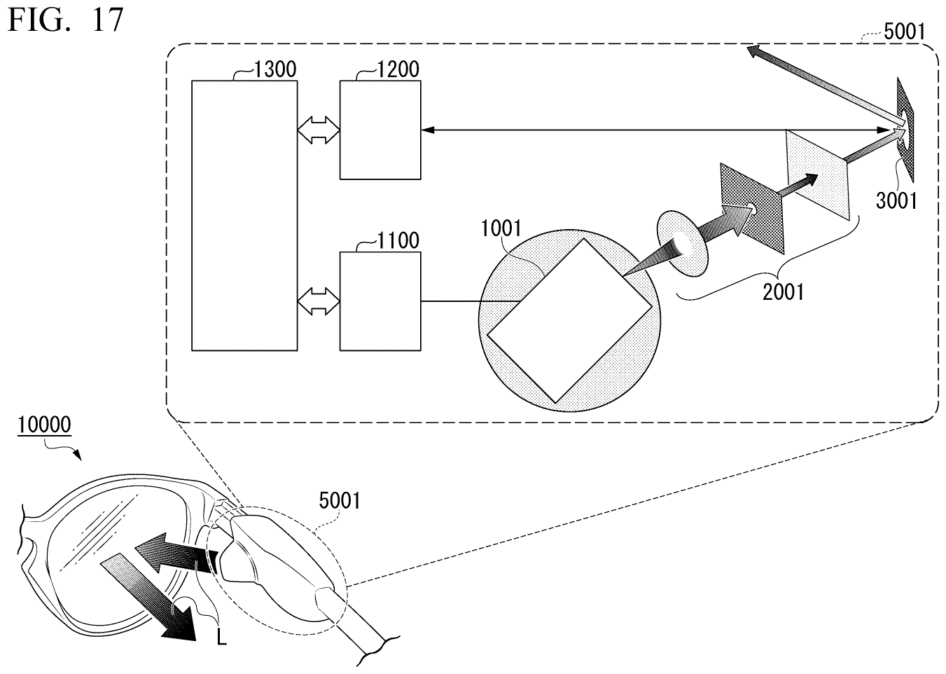

FIG. 17 shows a conceptual diagram showing an optical engine 5001 according to this embodiment. The drawing shows a state in which the optical engine 5001 is installed in a frame 10010 of glasses 10000. Symbol Lis image display light.

The optical engine 5001 includes a visible light source module 1001 and a light scanning mirror 3001. As the visible light source module 1001 included in the optical engine 5001, the visible light source module according to the embodiment described above is used.

Laser light emitted from the visible light source module 1001 installed in a glasses frame is reflected and scanned by the light scanning mirror, enters the human eye, and an image (a video) is directly projected onto the retina.

The light scanning mirror 3001 is, for example, a MEMS mirror. In order to project a 2D image, it is preferably a two-axis MEMS mirror that vibrates to reflect laser light while an angle thereof is changed in a horizontal direction (an X direction) and a vertical direction (a Y direction).

The optical engine 5001 includes a collimator lens 2001a, a slit 2001b, and an ND filter 2001c as an optical system that optically processes the laser light emitted from the visible light source module 1001. This optical system is just an example, and other configurations may be used.

The optical engine 5001 includes a laser driver 1100, a light scanning mirror driver 1200, and a video controller 1300 that controls the drivers.

### EXAMPLES

Hereinafter, the present disclosure will be described in more detail using examples. However, the present disclosure is not limited to the examples shown below.

<3-Input and 1-Output Type>

The coupling loss of light of three RGB colors in a model of the two-stage optical coupler including the wide MMI type optical coupling part and the narrow MMI type optical coupling part shown in FIG. 1 (loss in light intensity at output after input light intensity passes through the two-stage MMI type optical coupler) was compared with that in a model of a one-stage optical coupler through a simulation. Fimmwave (created by Photon Design Co.) was used as simulation software.

### Comparative Example 1

A simulation on a two-stage optical coupler of the MMI type optical coupling part according to the present disclosure was performed using a one-stage optical coupler of the MMI type optical coupling part as a comparative example with the following dimensions.
Width of MMI type optical coupling part: 13 μm
Length of MMI type optical coupling part: 5552 μm

Furthermore, in the arrangement of input of three colors of RGB, center input was set to blue (B).

The coupling losses were 6.0 dB, 6.0 dB, and 6 dB in the order of RGB.

### Example 1 to Example 9

In Examples 1 to 9, the length of a first stage MMI type optical coupling part is about 325 μm, the length of a second stage MMI type optical coupling part is about 670 μm, and a total length of the two stages is about 995 μm.

Example 2 had the following dimensions.
Width of first MMI type optical coupling part: 13 μm
Width of second MMI type optical coupling part: 7 μm
Length of first MMI type optical coupling part: 325 μm
Length of second MMI type optical coupling part: 670 μm

In addition, in the arrangement of input of three colors of RGB, center input was set to blue (B).

The coupling losses were 4.6 dB, 4.7 dB and 3.9 dB in order of RGB.

In Examples 1 and 3 to 9, each dimension of Example 2 is changed to ±.

In Examples 1 and 3, the length of the first stage MMI type optical coupling part is shortened by 10 μm and elongated by 10 μm compared to Example 2, respectively.

In Examples 4 and 5, the length of the second stage MMI type optical coupling part is shortened by 9 μm and elongated by 8 μm compared to Example 2, respectively.

In Examples 6 and 7, the width of the first stage MMI type optical coupling part is widened by 0.3 μm and narrowed by 0.2 μm compared to Example 2, respectively.

In Examples 8 and 9, the width of the second stage MMI type optical coupling part is narrowed by 0.18 μm and widened by 0.25 μm compared to Example 2, respectively.

The coupling loss of each of the examples is shown in Table 1.

### Example 10 to Example 18

In Examples 10 to 18, the length of the first stage MMI type optical coupling part is about 345 μm, the length of the second stage MMI type optical coupling part is about 680 μm, and a total length of the two stages is about 1025 μm.

Example 10 had the following dimensions.
Width of the first stage optical coupling part: 13 μm
Width of the second stage optical coupling part: 7 μm
Length of the first stage optical coupling part: 345 μm
Length of the second stage optical coupling part: 680 μm

In addition, in the arrangement of input of three colors of RGB, the center input was set to blue (B).

The coupling losses were 5.0 dB, 5.1 dB, and 3.5 dB in the order of RGB.

In Examples 11 to 18, each dimension of Example 10 is changed to +.

In Examples 11 and 12, the length of the first stage MMI type optical coupling part is shortened by 10 μm and elongated by 13 μm compared to Example 10, respectively.

In Examples 13 and 14, the length of the second stage MMI type optical coupling part is shortened by 10 μm and elongated by 15 μm compared to Example 10, respectively.

In Examples 15 and 16, the width of the first stage MMI type optical coupling part is widened by 0.5 μm and narrowed by 0.5 μm compared to Example 10, respectively.

In Examples 17 and 18, the width of the second stage MMI type optical coupling part is narrowed by 0.3 μm and widened by 0.4 μm compared to Example 10, respectively.

The coupling loss of each of the examples is shown in Table 1.

### Example 19 to Example 27

In Examples 19 to 27, the length of the first stage MMI type optical coupling part is about 340 μm, the length of the second stage MMI type optical coupling part is about 710 μm, and a total length of the two stages is about 1050 μm.

Example 19 had the following dimensions.
Width of the first stage optical coupling part: 13 μm
Width of the second stage optical coupling part: 7 μm
Length of the first stage optical coupling part: 340 μm
Length of the second stage optical coupling part: 710 μm

In addition, in the arrangement of input of three colors of RGB, the center input was set to blue (B).

The coupling losses were 5.3 dB, 5.0 dB, and 4.9 dB in the order of RGB.

In Examples 20 to 27, each dimension of Example 19 is changed to ±.

In Examples 20 and 21, the length of the first stage MMI type optical coupling part is shortened by 16 μm and elongated by 20 μm compared to Example 19, respectively.

In Examples 22 and 23, the length of the second stage MMI type optical coupling part is shortened by 30 μm and elongated by 40 μm compared to Example 19, respectively.

In Examples 24 and 25, the width of the first stage MMI type optical coupling part is widened by 0.6 μm and narrowed by 0.6 μm compared to Example 19, respectively.

In Examples 26 and 27, the width of the second stage MMI type optical coupling part is narrowed by 0.5 μm and widened by 0.5 μm compared to Example 19, respectively.

The coupling loss of each of the examples is shown in Table 1.

### Example 28 to Example 29

In Examples 28 to 29, the arrangement of the input of the three colors of RGB is performed so that the central input is red (R) and green (G), respectively, and the dimensions of each of them are as follows.

Example 28 had the following dimensions.
Width of the first stage optical coupling part: 13 μm
Width of the second stage optical coupling part: 7 μm
Length of the first stage optical coupling part: 480 μm
Length of the second stage optical coupling part: 950 μm

The coupling losses were 5.0 dB, 7.0 dB, and 5.0 dB in the order of RGB.

Example 29 had the following dimensions.
Width of the first stage optical coupling part: 13 μm
Width of the second stage optical coupling part: 7 μm
Length of the first stage optical coupling part: 480 μm
Length of the second stage optical coupling part: 480 μm

The coupling losses were 6.5 dB, 5.0 dB, and 5.0 dB in the order of RGB.

<2-Input and 1-Output Type>

The coupling loss of light of two RG colors in a model of the two-stage optical coupler including the wide MMI type optical coupling part and the narrow MMI type optical coupling part shown in FIG. 2 (loss in light intensity at output after input light intensity passes through the two-stage MMI type optical coupler) was compared with that in a model of a one-stage optical coupler through a simulation.

### Comparative Example 2

Comparative Example 2 had the following dimensions.
Width of MMI type optical coupling part: 6.5 μm
Length of MMI type optical coupling part: 850 μm

The coupling loss was 3.5 dB for both RG.

### Example 30

Example 30 had the following dimensions.
Width of first stage MMI type optical coupling part: 6.5 μm
Width of second stage MMI type optical coupling part: 3.5 μm
Length of first stage MMI type optical coupling part: 160 μm
Length of second stage MMI type optical coupling part: 390 μm
Total length of first and second stage MMI type optical coupling part: 550 μm

The coupling loss was 3.0 dB and 3.5 dB in the order of RG.

TABLE 1

| | | | | Width of MMI | | Length of MMI | | Length | | | |
|---|---|---|---|---|---|---|---|---|---|---|---|
| | | | | (μm) | | (μm) | | (μm) | Coupling loss | | |
| | | Configuration | Center | First | Second | First | Second | First stage + | (dB) | | |
| | | of MMI | wavelength | stage | stage | stage | stage | second stage | R | G | B |
| Examples | 1 | Two-stage MMI | B | 13 | 7 | 315 | 670 | 985 | 3.6 | 6.0 | 6.0 |
| (3-input) | 2 | Two-stage MMI | B | 13 | 7 | 325 | 670 | 995 | 4.6 | 4.7 | 3.9 |
| | 3 | Two-stage MMI | B | 13 | 7 | 335 | 670 | 1005 | 6.0 | 3.9 | 3.2 |
| | 4 | Two-stage MMI | B | 13 | 7 | 325 | 661 | 986 | 4.6 | 6.0 | 5.2 |
| | 5 | Two-stage MMI | B | 13 | 7 | 325 | 678 | 1003 | 6.0 | 4.3 | 3.4 |
| | 6 | Two-stage MMI | B | 13.3 | 7 | 325 | 670 | 995 | 6.0 | 5.0 | 4.1 |
| | 7 | Two-stage MMI | B | 12.8 | 7 | 325 | 670 | 995 | 5.1 | 6.0 | 5.1 |
| | 8 | Two-stage MMI | B | 13 | 6.82 | 325 | 670 | 995 | 6.0 | 4.2 | 4.0 |
| | 9 | Two-stage MMI | B | 13 | 7.25 | 325 | 670 | 995 | 4.0 | 6.0 | 4.3 |
| | 10 | Two-stage MMI | B | 13 | 7 | 345 | 680 | 1025 | 5.0 | 5.1 | 3.5 |
| | 11 | Two-stage MMI | B | 13 | 7 | 335 | 680 | 1015 | 6.0 | 5.5 | 4.0 |
| | 12 | Two-stage MMI | B | 13 | 7 | 358 | 680 | 1038 | 5.5 | 6.0 | 4.5 |
| | 13 | Two-stage MMI | B | 13 | 7 | 345 | 670 | 1015 | 5.5 | 6.0 | 4.0 |
| | 14 | Two-stage MMI | B | 13 | 7 | 345 | 695 | 1040 | 6.0 | 5.3 | 4.5 |
| | 15 | Two-stage MMI | B | 13.5 | 7 | 345 | 680 | 1025 | 6.0 | 5.5 | 4.0 |
| | 16 | Two-stage MMI | B | 12.5 | 7 | 345 | 680 | 1025 | 5.5 | 6.0 | 4.6 |
| | 17 | Two-stage MMI | B | 13 | 6.7 | 345 | 680 | 1025 | 6.0 | 5.5 | 4.0 |
| | 18 | Two-stage MMI | B | 13 | 7.4 | 345 | 680 | 1025 | 5.5 | 6.0 | 4.3 |
| | 19 | Two-stage MMI | B | 13 | 7 | 340 | 710 | 1050 | 5.3 | 5.0 | 4.9 |
| | 20 | Two-stage MMI | B | 13 | 7 | 324 | 710 | 1034 | 6.0 | 5.5 | 5.2 |
| | 21 | Two-stage MMI | B | 13 | 7 | 360 | 710 | 1070 | 5.5 | 6.0 | 4.9 |
| | 22 | Two-stage MMI | B | 13 | 7 | 340 | 680 | 1020 | 5.5 | 6.0 | 5.0 |
| | 23 | Two-stage MMI | B | 13 | 7 | 340 | 750 | 1090 | 6.0 | 5.7 | 5.4 |
| | 24 | Two-stage MMI | B | 13.6 | 7 | 340 | 710 | 1050 | 6.0 | 5.5 | 5.6 |
| | 25 | Two-stage MMI | B | 12.4 | 7 | 340 | 710 | 1050 | 5.6 | 6.0 | 5.0 |
| | 26 | Two-stage MMI | B | 13 | 6.5 | 340 | 710 | 1050 | 5.5 | 6.0 | 5.3 |
| | 27 | Two-stage MMI | B | 13 | 7.5 | 340 | 710 | 1050 | 6.0 | 5.7 | 5.3 |
| | 28 | Two-stage MMI | R | 13 | 7 | 480 | 950 | 1430 | 5.0 | 7.0 | 5.0 |
| | 29 | Two-stage MMI | G | 13 | 7 | 480 | 480 | 960 | 6.5 | 5.0 | 5.0 |
| Example | 30 | Two-stage MMI | | 6.5 | 3.5 | 160 | 390 | 550 | 3.0 | 3.5 | |
| (2-input) | | | | | | | | | | | |
| Comparative | 1 | One-stage MMI | G | 13 | — | 5552 | — | — | 6.0 | 6.0 | 6.0 |
| example | | | | | | | | | | | |
| (3-input) | | | | | | | | | | | |
| Comparative | 2 | One-stage MMI | | 6.5 | — | 850 | — | — | 3.5 | 3.5 | |
| example | | | | | | | | | | | |
| (2-input) | | | | | | | | | | | |

In performing the above simulation, the dimensions of the model of the optical coupler were determined on the basis of the following rules.

First, for two of the three colors of RGB, the MMI dimension at which the light intensity of both colors is 0.3 or more is calculated from the least common multiple of the beat length Lx. The MMI is fixed at the calculated dimensions, the light intensity of the remaining one color is calculated, and the dimension with the maximum intensity is determined as the optimal dimension.

When the dimensions of the model of the optical coupler were determined on the basis of the above rules, for any of the optical couplers of Examples 1 to 29 which are 3×1 type optical couplers, the total length of the first and second stage MMIs is about 1000 μm which was about ⅕ of the length of the MMI of Comparative Example 1 (5552 μm).

In particular, for Examples 1 to 27 in which the laser light disposed at the center was blue (B) among RGB, the total length of the first and second stage MMIs was 950 μm to 1050 μm, and also the coupling loss in all RGB was better than or the same as that of Comparative Example 1. That is, in Examples 1 to 27, the total length of MMI could be significantly reduced without sacrificing the coupling loss. Regarding the width of the MMI, the cases in which the width of the MMI was 0.3 μm, 0.5 μm and 0.6 μm larger than the width of the comparative example in Examples 6, 15 and 24, respectively, are confirmed, a significant reduction in the coupling loss was obtained for two of the three colors of RGB, and a significant reduction was achieved with only a slight sacrifice in the width of MMI.

In Example 30 which is a 2×1 type optical coupler, the total length of the first and second stage MMIs was 550 μm, which was 30% or more shorter than the length of the MMI of Comparative Example 2 (850 μm).

### DESCRIPTION OF REFERENCES

10 Substrate
20 Optical coupling functional layer
30, 130 Visible laser light source
40 Mach-Zehnder type optical modulator
50, 51, 150 Two-stage MMI type optical coupling part
50-1, 51-1, 150-1 First MMI type optical coupling part
50-2, 51-2, 150-2 Second MMI type optical coupling part
100, 101, 102, 200, 210 Optical coupler
300 Optical coupler with light modulation function
1000, 1010, 2000 Visible light source module

What is claimed is:

1. An optical coupler that couples laser lights of a plurality of different wavelengths,
wherein a first MMI type optical coupling part and a second MMI type optical coupling part are connected from an input side, and
a width of the first MMI type optical coupling part is wider than a width of the second MMI type optical coupling part.

2. The optical coupler according to claim 1,
wherein all of the plurality of different wavelengths are visible light wavelengths.

3. The optical coupler according to claim 1,
wherein the optical coupler is a 3-input and 1-output optical coupler, and
the optical coupler is configured so that laser lights of three colors are input and the laser light input from a center is laser light with a shortest wavelength.

4. The optical coupler according to claim 3,
wherein the three colors are respectively a red wavelength of 610 nm or more and 750 nm or less, a green wavelength of 500 nm or more and 560 nm or less, and a blue wavelength of 435 nm or more and 480 nm or less.

5. The optical coupler according to claim 4,
wherein a connection portion of the second MMI type optical coupling part with the first MMI type optical coupling part has a taper of which a width becomes wider as the taper approaches the first MMI type optical coupling part.

6. The optical coupler according to claim 1, further comprising:
a substrate made of a material different from lithium niobate; and
an optical coupling functional layer formed on a main surface of the substrate and made of a lithium niobate film,
wherein the optical coupler is formed in the optical coupling functional layer.

7. A visible light source module comprising:
the optical coupler according to claim 6; and
a plurality of visible laser light sources configured to emit visible lights that are coupled by the optical coupler.

8. An optical coupler with a light modulation function, comprising:
the optical coupler according to claim 6; and
a Mach-Zehnder type optical modulator connected to the optical coupler and configured to guide a plurality of visible lights emitted from a plurality of visible laser light sources to the optical coupler.

9. A visible light source module comprising:
the optical coupler with a light modulation function according to claim 8; and
a plurality of visible laser light sources configured to emit visible lights that are coupled by the optical coupler with a light modulation function.

10. An optical engine comprising:
the visible light source module according to claim 7; and
a light scanning mirror that reflects light emitted from the visible light source module by changing an angle to display an image.

11. An optical engine comprising:
the visible light source module according to claim 9, and
a light scanning mirror that reflects light emitted from the visible light source module by changing an angle to display an image.
